(19) United States
(12) Patent Application Publication
(10) Pub. No.: US 2015/0118122 A1
(43) Pub. Date: Apr. 30, 2015

(54) MEMBRANE REACTOR WITH DIVERGENT-FLOW CHANNEL

(71) Applicant: ATOMIC ENERGY COUNCIL - INSTITUTE OF NUCLEAR ENERGY RESEARCH, Taoyuan County (TW)

(72) Inventors: YAU-PIN CHYOU, TAOYUAN COUNTY (TW); YU-SHAO LIN, TAOYUAN COUNTY (TW); PO-CHUANG CHEN, TAOYUAN COUNTY (TW); WEN-JENN SHEU, TAOYUAN COUNTY (TW); YEN-CHO CHEN, TAOYUAN COUNTY (TW); CHIEN-CHON CHEN, TAOYUAN COUNTY (TW)

(73) Assignee: ATOMIC ENERGY COUNCIL - INSTITUTE OF NUCLEAR ENERGY RESEARCH, Taoyuan County (TW)

(21) Appl. No.: 14/264,264

(22) Filed: Apr. 29, 2014

(30) Foreign Application Priority Data
Oct. 29, 2013 (TW) 102139060

(51) Int. Cl. B01J 15/00

(52) U.S. Cl. CPC B01J 15/005
USPC 422/187

(57) ABSTRACT

A membrane reactor with divergent-flow channel includes a reaction pipeline, a membrane and a purge (sweep) pipeline sequentially arranged from inside to outside or from outside to inside. The reaction pipeline has a cross-sectional area increment from the front (upstream) end to the rear (downstream) end, so that the flow velocity of a reactant gas is decreased from the upstream end to the downstream end to extend the residence time of the reactant gas and improve the reaction rate of the reactant gas. The sweep pipeline has a cross-sectional area decrement from the upstream end to the downstream end, so that the flow velocity of a purging (sweeping) gas is increased from the upstream end to the downstream end to accelerate the reactant gas, and a product gas generated from the reaction passes through the membrane and enters the sweep pipeline to improve the reaction efficiency.

### FIELD OF THE INVENTION

The present invention relates to a membrane reactor, and more particularly to a membrane reactor with divergent-flow channel having a reaction pipeline with increasing cross-sectional area from the upstream end to the downstream end of the reaction pipeline, so that the flow velocity of a reactant gas passing through the reaction pipeline is decreased, so as to improve the reaction performance of the membrane reactor.

### BACKGROUND OF THE INVENTION

In general, a membrane reactor used for chemical reactions primarily combines catalysis and membrane separation technology to promote the efficiency of the reactor, and thus the membrane reactor has both reaction catalysis and product separation functions. Compared with a conventional fixed-bed reactor, the membrane reactor can improve the yield rate and purity of the products significantly.

The membrane reactor has the following characteristics:

1. The membrane can be implemented to let the products be removed by selective diffusion or absorption. According to the Le Chatelier's principle, the chemical equilibrium of the reaction shifts toward the product end to improve the conversion rate of the reaction. Particularly, the membrane reactor enhances the efficiency of equilibrium-limited reactions that a conventional reactor cannot break through, such as ammonia synthesis reaction (N2+3H₂→2NH₃) or water-gas shift reaction (CO+H₂O→CO₂+H₂).
2. Since the reacting product leaves the reaction system quickly, the occurrence of side effects and the producing of by-products can be avoided to improve the selectivity of the reaction.
3. Since the product selectively passes through the membrane to improve the purity of the product, and the membrane can be utilized to concentrate the product for increasing the concentration of the product.
4. The chemical reaction and product separation can be operated in the same membrane reactor to simplify the technological process to lower the cost and reduce the installation space.
5. Since the catalyst used in the membrane reactor can improve the conversion rate of the chemical reaction, therefore the reaction can take place more easily and achieve the effects of lowering the reaction temperature and the reaction pressure to improve the selectivity of the reaction while reducing the energy consumption.

With reference to FIG. 1 for a conventional membrane reactor, the conventional membrane reactor comprises a reaction pipeline 10, a membrane 12 and a sweep pipeline 14, wherein the membrane 12 is disposed on an external side of the reaction pipeline 10, and the sweep pipeline 14 is installed on an external side of the membrane 12, and a catalyst layer 16 is filled into the reaction pipeline 10, and an outer wall 18 is disposed on the exterior of the sweep pipeline 14, and the diameters of the reaction pipeline 10 and the sweep pipeline 14 remain constant respectively along flow direction. In FIG. 1, after two reactant gases G0 and G0′ enter the reaction pipeline 10, the reaction of reactant gases G0 and G0′ are catalyzed by the catalyst layer 16 and generate two product gases G2 and G2′. The membrane 12 has a selective permeability of the product gas G2. After the product gas G2 is generated, it passes from the reaction pipeline 10 into the sweep pipeline 14 via permeating the membrane 12, and a purge gas G1 enters the sweep pipeline 14 to carry the product gas G2 away. The product gas G2′ exits from the other end of the reaction pipeline 10. According to the Le Chatelier's principle as described above, the purge gas G1 removes the product gas G2, thus improving the performance of the membrane reactor.

To further improve the performance of the membrane reactor, the inventor of the present invention designed and developed a membrane reactor with divergent-flow channel having a reaction pipeline with increasing cross-sectional area, so that the flow velocity of a reactant gas in reaction pipeline is decreased to extend the residence time of the reactant gas in the reaction pipeline, so as to increase the reaction rate of the reactant gas for the reaction. On the other hand, the decreasing cross-sectional area of the sweep pipeline increases the flow velocity of the purge gas in the sweep pipeline for carrying the product gas away, which accelerates the removal of the product gas. Therefore, the performance of the membrane reactor with divergent-flow channel of the present invention can be further improved by changing the cross-sectional area of the reaction pipeline and the sweep pipeline.

### SUMMARY OF THE INVENTION

It is a primary objective of the present invention to provide a membrane reactor with divergent-flow channel having a reaction pipeline with a cross-sectional area increment from the front (upstream) end to the rear (downstream) end, so that the flow velocity of a reactant gas is decreased from the upstream end to the downstream end. Thus the residence time of the reactant gas in the reaction pipeline can be extended, and the performance of the membrane reactor is improved due to longer reaction time.

A secondary objective of the present invention is to provide a membrane reactor with divergent-flow channel having a sweep pipeline with a cross-sectional area decrement from the upstream and to the downstream end, so that the flow velocity of the purge gas is increased from the upstream end to the downstream end, and the removal rate of a product gas is enhanced to change the equilibrium of the reaction, so as to further improve the performance of the membrane reactor.

To achieve the aforementioned objectives and effects, the present invention provides a membrane reactor with divergent-flow channel comprising a reaction pipeline, a membrane and a sweep pipeline, wherein the reaction pipeline has a cross-sectional area increment from the upstream end to the downstream end of the reaction pipeline, and the sweep pipeline is installed on an external side of the reaction pipeline, and the membrane is installed between the reaction pipeline and the sweep pipeline to separate the reaction pipeline from the sweep pipeline, and a reactant gas flows into the reaction pipeline and is provided for a reaction to generate a product gas, and the product gas passes through the membrane and enters the sweep pipeline, then is carried to the outside by a purge gas.

The present invention also discloses a membrane reactor with divergent-flow channel comprising a reaction pipeline, a membrane and a sweep pipeline, wherein the reaction pipeline has a cross-sectional area increment from the upstream end to the downstream end of the reaction pipeline. The difference between the membrane reactor with divergent flow channel and the previous one is that the configuration of the reaction pipeline and the sweep pipeline is adverse, in which the reaction pipeline is installed on an external side of the sweep pipeline, while the membrane is still installed between the reaction pipeline and the sweep pipeline to separate the reaction pipeline from the sweep pipeline. Similarly, a reactant gas flows into the reaction pipeline for a reaction to generate a product gas, and part of the product gas passes through the membrane and enters the sweep pipeline, and finally id carried away by a purge gas.

The aforementioned two types of membrane reactors with divergent-flow channel have the primary structural characteristic of the present invention. In other words, the reaction pipeline has a cross-sectional area increment from the upstream end to the downstream end of the reaction pipeline, and such characteristic decreases the flow velocity of the reactant gas from the upstream end to the downstream end to extend the residence time of the reactant gas in the reaction pipeline and increase the reaction rate of the reactant gas, so as to improve the performance of the membrane reactor with divergent flow channel of the present invention.

In addition, the aforementioned two types of membrane reactors with divergent-flow channel further have the secondary structural characteristic of the present invention. In other words, the sweep pipeline has a cross-sectional area decrement from the upstream end to the downstream end of the sweep pipeline, and such characteristic can increase the flow velocity from the upstream end to the downstream end of the purge gas to accelerate the removal of the product gas diffused to the sweep pipeline, so that the product gas can diffuse at a higher rate from the reaction pipeline to the sweep pipeline to change the equilibrium of the reaction in the reaction pipeline. The reaction thus tends to have a reaction direction of generating the product gas from the reactant gas to reduce the occurrence of a reverse reaction, so as to further improve the reaction performance of the aforementioned two types of membrane reactors with divergent-flow channel of the present invention.

### BRIEF DESCRIPTION OF THE DRAWINGS

FIG. 1 is a schematic view of a conventional membrane reactor;

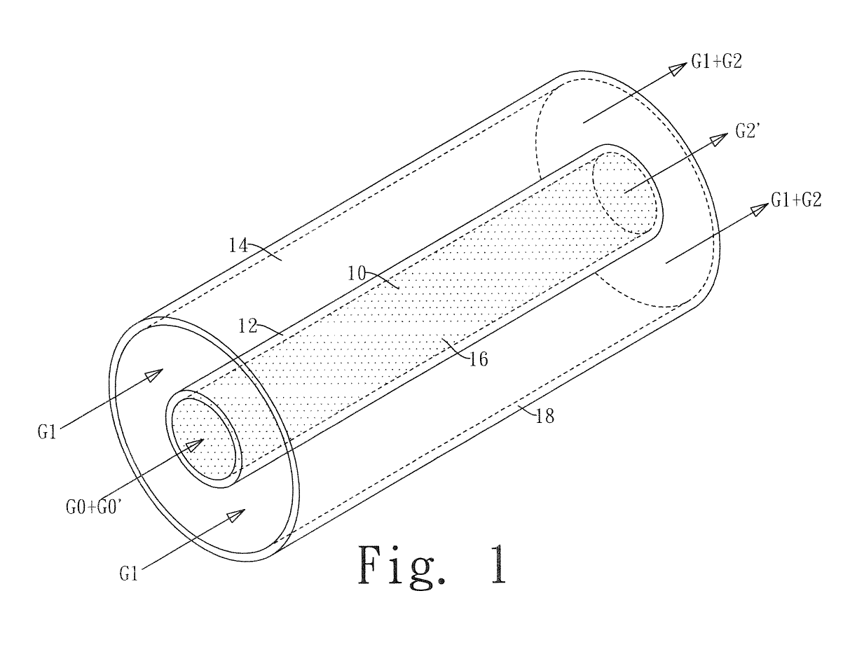

FIG. 2A is a schematic view of a first preferred embodiment of the present invention;

FIG. 2B is a graph showing the conversion rate of a raw material gas in accordance with the first preferred embodiment of the present invention;

FIG. 2C is a graph showing the recovery rate of a generated gas in accordance with the first preferred embodiment of the present invention;

FIG. 3 is a schematic view of a second preferred embodiment of the present invention;

FIG. 4 is a schematic view of a third preferred embodiment of the present invention;

FIG. 5 is a schematic view of a fourth preferred embodiment of the present invention;

FIG. 6 is a schematic view of a fifth preferred embodiment of the present invention; and

FIG. 7 is a schematic view of a sixth preferred embodiment of the present invention.

### DESCRIPTION OF THE PREFERRED EMBODIMENTS

The technical characteristics of the present invention will become clearer in light of the following detailed description of illustrative preferred embodiments of this invention. It is intended that the preferred embodiments disclosed herein are to be considered illustrative rather than restrictive.

The diverging membrane reactor of the present invention is characterized by the structure of the reaction pipeline having a cross-sectional area increment from the upstream end to the downstream end to decrease the flow velocity of the reactant gas from the upstream end to the downstream end and extend the residence time of the reactant gas in the reaction pipeline. In the meantime, the structure of the sweep pipeline having a cross-sectional area decrement from the upstream end to the downstream end of the sweep pipeline to increase the flow velocity of the purge gas from the upstream end to the downstream end and enhance the removal of the product gas diffused to the sweep pipeline, thus increasing the diffusion rate of the product gas to change the equilibrium of the reaction, so as to improve the performance of the membrane reactor.

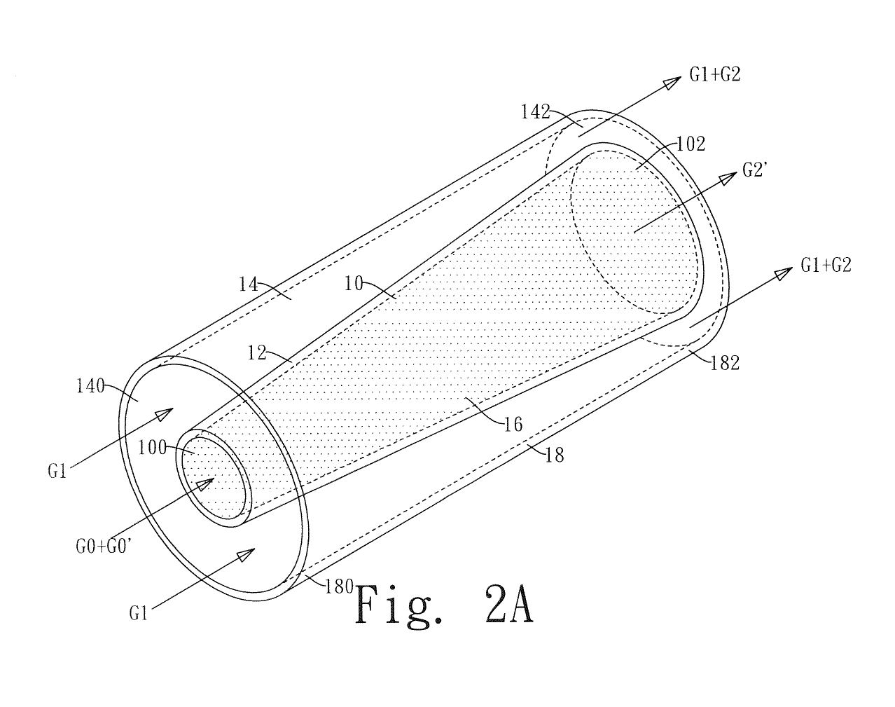

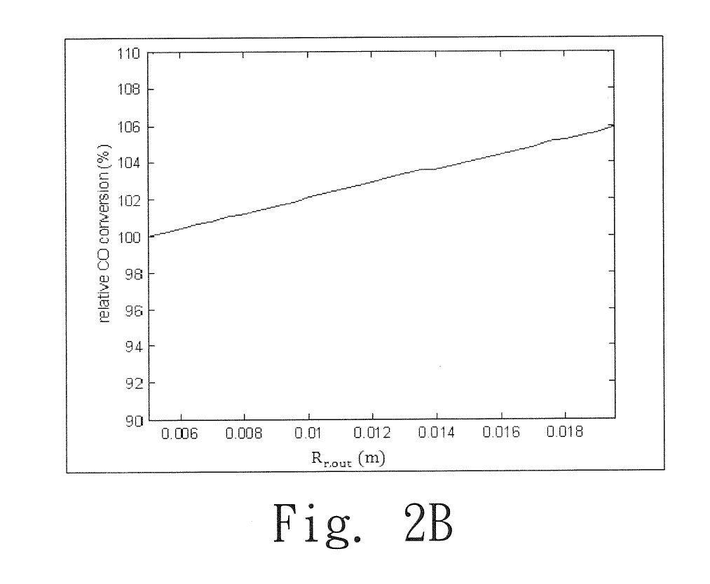

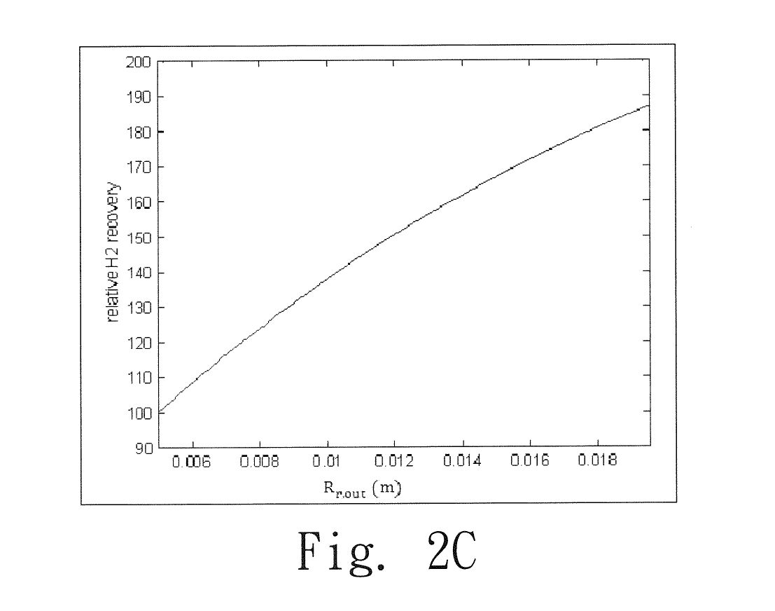

With reference to FIGS. 2A, 2B and 2C for a schematic view of a membrane reactor with divergent-flow channel, a graph showing the conversion rate of a reactant gas, and a graph showing the recovery rate of a product gas in accordance with the first preferred embodiment of the present invention respectively, the membrane reactor with divergent-flow channel comprises a reaction pipeline 10, a membrane 12 and a sweep pipeline 14, wherein the sweep pipeline 14 is installed on an external side of the reaction pipeline 10, and the membrane 12 is installed between the reaction pipeline 10 and the sweep pipeline 14 to separate the reaction pipeline 10 from the sweep pipeline 14, and the membrane reactor with divergent-flow channel of this preferred embodiment has a tubular structure, and the reaction pipeline 10 has an internal diameter increment from the upstream end 100 to the downstream end 102 of the reaction pipeline 10, so that the reaction pipeline 10 has a cross-sectional area increment from the upstream end 100 to the downstream end 102. In addition, the reaction pipeline 10 includes a catalyst layer 16 disposed therein, and the catalyst layer 16 includes a plurality of pores and is filled into the interior space of the reaction pipeline 10.

When the membrane reactor with divergent-flow channel of the present invention is in operation, a reactant gas G0 enters the reaction pipeline 10 and flows from the upstream end 100 to the downstream end 102. In the process, the reactant gas G0 is catalyzed by the catalyst layer 16 and reacted to generate a product gas G2, and the membrane 12 has a selective permeability of the product gas G2, which means at least a part of the product gas can pass from the reaction pipeline into the sweep pipeline through the membrane. After the product gas G2 is generated, part of the product gas G2 passes through the membrane 12 and enters the sweep pipeline 14 from the reaction pipeline 10, and a purge gas G1 enters from the upstream end 140 to the downstream end 142 of the sweep pipeline 14 to carry the product gas G2 to the outside.

Since the reaction pipeline 10 of the present invention has a cross-sectional area increment from the upstream end 100 to the downstream end 102, therefore when the reactant gas G0 flows from the upstream end 100 to the downstream end 102 of the reaction pipeline 10, the flow velocity is decreased to extend the residence time of the reactant gas G0 in the reaction pipeline 10, and increase the chance of being catalyzed by the catalyst layer 16 for the reaction. Therefore, the structure of the reaction pipeline 10 having a cross-sectional area increment from the upstream end 100 to the downstream end 102 can increase the reaction rate of the reactant gas G0 for the reaction. In other words, the reaction performance of the membrane reactor with divergent-flow channel of the present invention can be improved.

In addition, the external side of the sweep pipeline 14 further includes an outer wall 18, and the sweep pipeline 14 is installed in a space between the outer wall 18 and the membrane 12. In this preferred embodiment, the outer wall 18 has a constant internal diameter from the upstream end 180 to the downstream end 182 of the outer wall 18, so that the sweep pipeline 14 has a cross-sectional area (wherein it is necessary to deduct the cross-sectional areas of the reaction pipeline 10 and the membrane 12) decrement from the upstream end 140 to the downstream end 142 of the sweep pipeline 14.

Since the sweep pipeline 14 of the present invention has a cross-sectional area decrement from the upstream end 140 to the downstream end 142, the flow velocity of the purge gas G1 is increased while flowing from the upstream end 140 to downstream end 142 of the sweep pipeline 14 to accelerate the speed for the purge gas G1 to move the product gas G2 out from the sweep pipeline 14 and improve the efficiency of driving the product gas G2 to diffuse from the reaction pipeline 10 into the sweep pipeline 14. As a result, the concentration of the product gas G2 in the reaction pipeline 10 is decreased, and it also drives the reaction toward the direction of generating the product gas G2 from the reactant gas G0, and reduces the reverse reaction. Therefore, the structure of the sweep pipeline 14 having a cross-sectional area decrement from the upstream end 140 to the downstream end 142 of the sweep pipeline 14 changes the equilibrium of the reaction in the reaction pipeline 10 and improve the reaction rate. In other words, the reaction performance of the membrane reactor with divergent-flow channel of the present invention can be improved further.

In this preferred embodiment, the reaction is a water-gas shift reaction, and carbon monoxide acts as the reactant gas G0, and water vapor acts as another reactant gas G0′, and the generated hydrogen gas acts as a product gas G2, and the generated carbon dioxide acts as another product gas G2′, and the reaction is expressed as follows:

Carbon Monoxide+Water Vapor→Carbon Dioxide+Hydrogen Gas

In the water-gas shift reaction, a membrane having a selective diffusion capability on the product gas G2 (hydrogen gas) such as a palladium metal film can be used as the membrane 12, and a catalyst capable of catalyzing the water-gas shift reaction such as an iron-chromium based catalyst, is a copper-zinc based catalyst, a cobalt-molybdenum based catalyst, a copper-cerium (lanthanum) based catalyst, a nickel-cerium (lanthanum) based catalyst, a rutherfordium/zirconium oxide catalyst, a gold/cerium oxide catalyst or a copper-palladium/cerium oxide catalyst can be used as the catalyst layer 16, and nitrogen or water vapor can be used as the purge gas G1.

In FIG. 2A, the reactant gas G0 (carbon monoxide) and the reactant gas G0′ (water vapor) enter the reaction pipeline 10 from the upstream end 100 of the reaction pipeline 10, then are catalyzed by the catalyst layer 16, and the water-gas shift reaction takes place to generate the product gas G2 (hydrogen gas) and the product gas G2′(carbon dioxide), and the membrane 12 selectively allows the product gas G2 (hydrogen gas) to pass through and exit the reaction pipeline 10 and to enter the sweep pipeline 14, and the purge gas G1 (nitrogen) enters the sweep pipeline 14 from the upstream end 140 of the sweep pipeline 14 to carry the product gas G2 (hydrogen gas) away from the downstream end 142 of the sweep pipeline 14. In addition, the product gas G2′ (carbon dioxide) exits from the downstream end 102 of the reaction pipeline 10.

To show that the membrane reactor with divergent-flow channel of the present invention has the effects of increasing the reaction rate of the reaction gas G0 (carbon monoxide) and improving the recovery rate of the product gas G2 (hydrogen gas) to enhance the overall reaction performance, the inventor of the present invention creates a computational model of the membrane reactor with divergent-flow channel of the present invention to simulate the water-gas shift reaction and examine the effects of the water-gas shift reaction. In the model, the lengths of both reaction pipeline 10 and sweep pipeline 14 are 8 cm, and the internal diameter of the sweep pipeline 14 remains at a constant value of 2 cm from the upstream end 140 to the downstream end 142 of the sweep pipeline 14, and the internal diameter of the reaction pipeline 10 varies from 0.5 cm at the upstream end 100 to 0.5˜1.95 cm at the downstream end 102, while the thickness of the membrane 12 is negligible.

FIG. 2B shows the conversion rate of the reactant gas G0 (carbon dioxide), wherein the Y-axis represents the relative conversion rate in terms of percentage, based on the standard case with a constant internal diameter of the reaction pipeline 10 (0.5 cm from the upstream end 100 to the downstream end 102), and the X-axis represents the internal diameter (unit in meter) of the downstream end 102 of the reaction pipeline 10. In the graph of FIG. 2B, as the internal diameter of the downstream end 102 of the reaction pipeline 10 increases, the conversion rate of the reactant gas G0 (carbon dioxide) also increases up to 5%, and thus showing that the membrane reactor with divergent-flow channel of the present invention can improve the reaction rate of the reactant gas G0 slightly.

FIG. 2C shows that recovery rate of the product gas G2 (hydrogen gas), and the Y-axis represents the relative recovery rate (in terms of percentage), based on the recovery rate of product gas G2 (hydrogen gas) in the reaction pipeline 10 with a constant internal diameter (0.5 cm from the upstream end 100 to the downstream end 102) as the standard, and the X-axis represents the internal diameter (unit in meter) of the downstream end 102 of the reaction pipeline 10. In the graph of FIG. 2C, as the internal diameter of the downstream end 102 of the reaction pipeline 10 increases, the recovery rate of the product gas G2 (hydrogen gas) can also increase by approximately 87%, which is almost equal to twice of the standard case, and thus showing that the divergent-flow-channel membrane reactor of the present invention can improve the rate of generating the product gas G2.

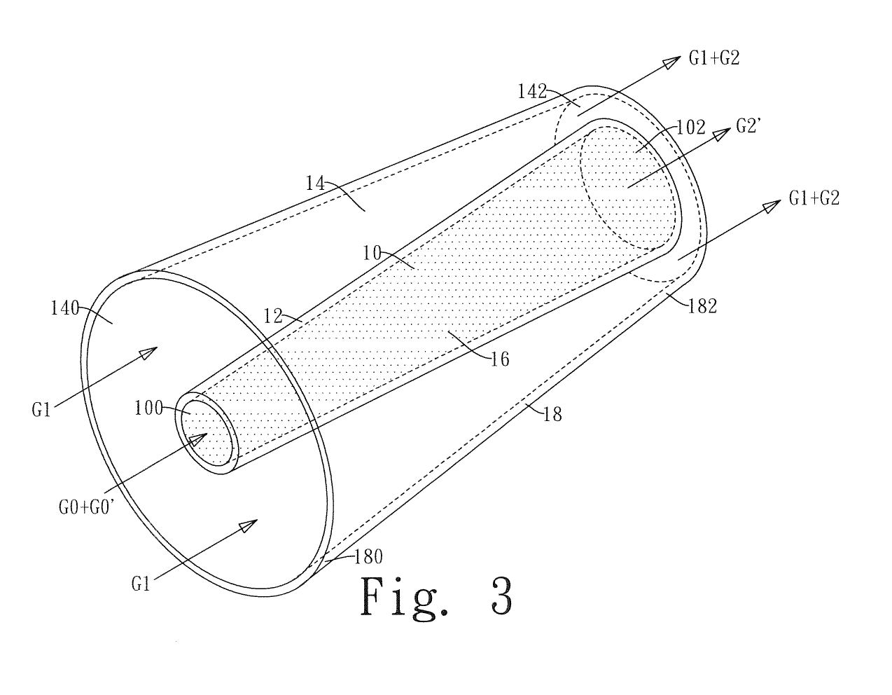

In FIGS. 2A and 3. FIG. 3 is a schematic view of the structure of the second preferred embodiment of the present invention, and the difference between this preferred embodiment and the first preferred embodiment resides on that the membrane reactor with divergent-flow channel of this preferred embodiment has the outer wall 18 with an internal diameter decreasing from the upstream end 180 and the downstream end 182 of the outer wall 18. Thus the cross-sectional area of the sweep pipeline 14 (wherein it is necessary to deduct the cross-sectional areas of the reaction pipeline 10 and the membrane 12) is decreased from the upstream end 140 and the downstream end 142 more drastically. Accordingly, when the purge gas G1 flowing in the sweep pipeline 14 approaches the downstream end 142 of the sweep pipeline 14, a higher flow velocity can be achieved to improve the efficiency of moving out the product gas G2 than that of the first preferred embodiment, so as to achieve a better performance of the membrane reactor.

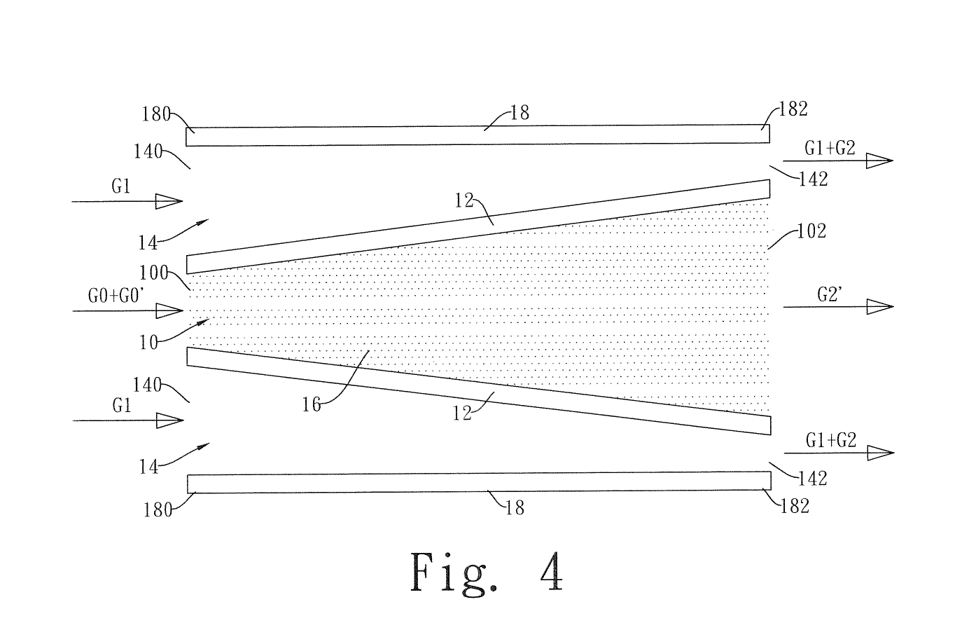

Referring to FIGS. 2A and 4, FIG. 4 is a schematic view showing the structure of the third preferred embodiment of the present invention, and the difference between this preferred embodiment and the first preferred embodiment resides on that the membrane reactor with divergent-flow channel of the preferred embodiment has a plate structure which is different from the tubular structure of the first preferred embodiment. In addition, the reaction pipeline 10 includes the catalyst layer 16 disposed therein, the sweep pipeline 14 is disposed on an external side of the reaction pipeline 10, the membrane 12 separates the reaction pipeline 10 from the sweep pipeline 14, the outer wall 18 limits the sweep pipeline 14, and the reaction pipeline 10 has a cross-sectional area increment from the upstream end 100 to the downstream end 102 of the reaction pipeline 10. In the meantime, the sweep pipeline 14 has a cross-sectional area decrement from the upstream end 140 to the downstream end 142 of the sweep pipeline 14, and the aforementioned characteristics are similar to those of the first preferred embodiment.

The aforementioned structural characteristics decrease the flow velocity of the reactant gas G0 or G0′ in the reaction pipeline 10 from the upstream end 100 to the downstream end 102 of the reaction pipeline 10, while the velocity of the purge gas G1 or the product gas G2 in the sweep pipeline 14 increase from the upstream end 140 to the downstream end 142. Similarly, the membrane reactor with divergent-flow channel of this preferred embodiment can achieve a better reaction performance.

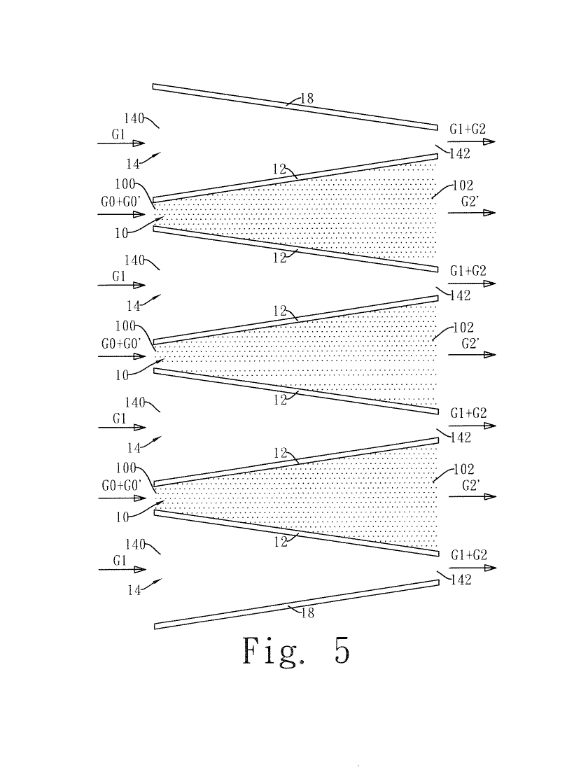

Referring to FIGS. 4 and 5, FIG. 5 is a schematic view showing the structure of the fourth preferred embodiment of the present invention. The difference between this preferred embodiment and the third preferred embodiment resides on that the membrane reactor with divergent-flow channel of this preferred embodiment is a plate structure with multi-layers, so that the plurality of reaction pipelines 10 and the plurality of sweep pipelines 14 can be installed alternately from the inside to the outside, and the reaction pipelines 10 and the sweep pipelines 14 can be separated by a plurality of membranes 12 respectively, and two outer walls 18 are disposed on the external side of the outermost sweep pipeline 14, and each reaction pipeline 10 has a catalyst layer 16 disposed therein for catalyzing the reaction.

With the structure of the membranes 12 and the outer walls 18, the cross-sectional area of each reaction pipeline 10 can be increased from the upstream end 100 to the downstream end 102 of the reaction pipeline 10, and the cross-sectional area of each sweep pipeline 14 can be decreased from the upstream end 140 to the downstream end 142 of the sweep pipeline 14, so that the flow velocity of the reactant gas G0, G0′ in the reaction pipeline 10 is decreased from the upstream end 100 to the downstream end 102 of the reaction pipeline 10, and the flow velocity of the purge gas G1 or the generated gas G2 in the sweep pipeline 14 is increased from the upstream end 140 to the downstream end 142 of the sweep pipeline 14, so that the membrane reactor with divergent-flow channel of this preferred embodiment also can achieve a better reaction performance. By installing the reaction pipelines 10 and the sweep pipelines 14 alternately, the total amount of product gas and overall is efficiency can be increased.

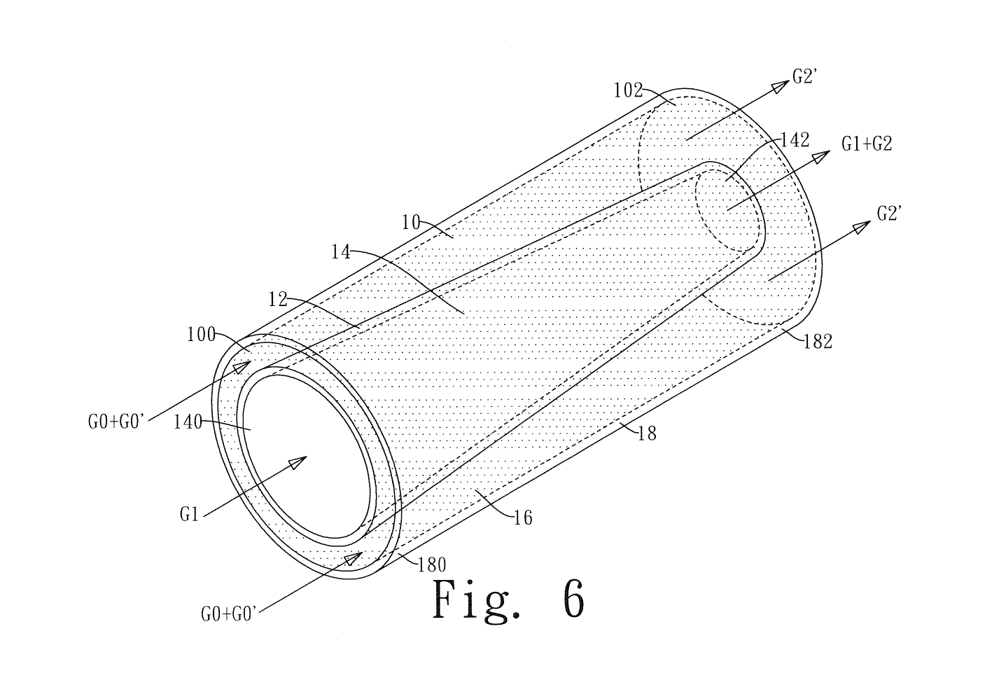

Referring to FIGS. 2A and 6, FIG. 6 shows a schematic structure of a membrane reactor with divergent-flow channel in accordance with the fifth preferred embodiment of the present invention. The membrane reactor with divergent-flow channel of this preferred embodiment also comprises a reaction pipeline 10, a membrane 12 and a sweep pipeline 14. This difference between this preferred embodiment and the first preferred embodiment resides on that the reaction pipeline 10 of this preferred embodiment is installed on an external side of the sweep pipeline 14, while the membrane 12 is still installed between the reaction pipeline 10 and the sweep pipeline 14 to separate the reaction pipeline 10 from the sweep pipeline 14, and a catalyst layer 16 having a plurality of pores is filled into the interior space of the reaction pipeline 10, and an outer wall 18 is disposed on an external side of the reaction pipeline 10. In other words, the reaction pipeline 10 is disposed in the space between the membrane 12 and the outer wall 18.

In this preferred embodiment, the sweep pipeline 14 has an internal diameter decrement from the upstream end 140 to the downstream end 142 of the sweep pipeline 14, so that the sweep pipeline 14 has a cross-sectional area decrement from the upstream end 140 to the downstream end 142, and the outer wall 18 has a constant internal diameter from the upstream end 180 to the downstream end 182 of the outer wall 18, so that the reaction pipeline 10 has a cross-sectional area (deducting the cross-sectional areas of the sweep pipeline 14 and the membrane 12) increment from the upstream end 100 to the downstream end 102 of the reaction pipe 10.

Similarly, a reactant gas G0 and another reactant gas G0′ enter the reaction pipeline 10 and flow from the upstream end 100 to the downstream end 102 of the reaction pipeline 10. In the process, the reactant gas G0, G0′ is catalyzed by the catalyst layer 16 and reacted to generate a product gas G2 and another product gas G2′, and the membrane 12 has a selective permeability of the product gas G2. After the product gas G2 is generated, the product gas G2 passes from the reaction pipeline 10 into the sweep pipeline 14 through the membrane 12, and a purge gas G1 flows from the upstream end 140 to the downstream end 142 of the sweep pipeline 14 to carry away the product gas G2, and finally the product gases G2 exit from the downstream end 102 of the reaction pipeline 10.

Therefore, the reaction pipeline 10 of the present invention has a cross-sectional area increment from the upstream end 100 to the downstream end 102 of the reaction pipeline 10, so that the flow velocity of the reactant gases G0, G0′ flowing from the upstream end 100 to the downstream end 102 of the reaction pipeline 10 can be decreased to extend the residence time of the reactant gases G0, G0′ in the reaction pipeline 10, so as to increase the chance of being catalyzed by the catalyst layer 16 for the reaction. In addition, the sweep pipeline 14 has a cross-sectional area decrement from the upstream end 140 to the downstream end 142, so that the flow velocity of the purge gas G1 flowing from the upstream end 140 to the downstream end 142 of the sweep pipeline 14 can be increased. Thus, the rate of the product gas G2 diffusing from the reaction pipeline 10 into the sweep pipeline 14 and then being removed out from the sweep pipeline 14 is accelerated. Accordingly, the concentration of the product gas G2 in the reaction pipeline 10 is reduced and the equilibrium of the reaction in the reaction pipeline 10 is changed. That is, the recreation rate is increased and the reaction performance of the divergent-flow-channel membrane reactor of the present invention is improved.

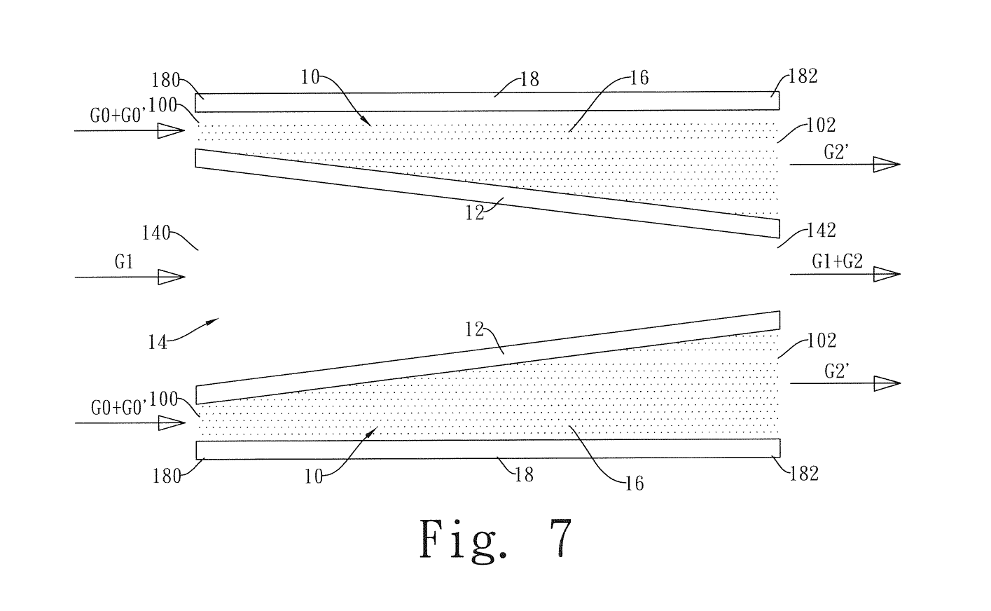

With reference to FIGS. 6 and 7 for schematic views of the sixth preferred embodiment of the present invention, the difference between this preferred embodiment and the fifth preferred embodiment resides on that the membrane reactor with divergent-flow channel of this preferred embodiment has a plate structure which is different from the tubular structure of the fifth preferred embodiment. In addition, the reaction pipeline 10 of this preferred embodiment is disposed on an external side of the sweep pipeline 14, and the membrane 12 separates the reaction pipeline 10 from the sweep pipeline 14, and the outer wall 18 limits the reaction pipeline 10, and the reaction pipeline 10 includes the catalyst layer 16 installed therein, and the sweep pipeline 14 has a cross-sectional area decrement from the upstream end 140 to the downstream end 142. In the meantime, the reaction pipeline 10 has a cross-sectional area increment from the upstream end 100 to the downstream end 102 of the reaction pipe 10. The aforementioned structural characteristics are similar to those of the fifth preferred embodiment.

The aforementioned structural characteristics decreases the flow velocity of the reactant gas G0 or/and G0′ in the reaction pipeline 10 from the upstream end 100 to the downstream end 102 and increases the flow velocity of the purge gas G1 or/and the product gas G2 in the sweep pipeline 14 from the upstream end 140 to the downstream end 142. Similarly, the membrane reactor with divergent-flow channel of this preferred embodiment can achieve a better reaction performance.

In conclusion, the present invention provides a membrane reactor with divergent-flow channel comprising a reaction pipeline, a membrane and a sweep pipeline, and the reaction pipeline, the membrane and the sweep pipeline are arranged sequentially from the inside to the outside or from the outside to the inside, characterized by that the reaction pipeline has a cross-sectional area increment from the upstream end to the downstream end, so that the flow velocity of a reactant gas in the reaction pipeline is decreased from the upstream end to the downstream end to extend the residence time of the reactant gas, so as to improve the reaction rate of the reactant gas. In addition, the sweep pipeline has a cross-sectional area decrement from the upstream end to the downstream end of the sweep pipeline, so the flow velocity of a purge gas in the sweep pipeline can be increased from the upstream end to the downstream end. As a result, the processes of the reactant in the reaction pipeline being reacted to generate the product gas, which then diffusing through the membrane to the sweep pipeline, can all be accelerated. By accelerating the product gas produced by the said process, the reaction efficiency is improved.

What is claimed is:

1. A membrane reactor with divergent-flow channel, comprising:
a reaction pipeline, having a cross-sectional area increment from the upstream end to the downstream end of the reaction pipeline, and a reaction gas being reacted in the reaction pipeline to generate a product gas;
a membrane, disposed on an external side of the reaction pipeline; and
a sweep pipeline, installed on an external side of the membrane, and at least a part of the product gas passing from the reaction pipeline into the sweep pipeline through the membrane, and a sweeping gas flowing from the upstream end to the downstream end of the sweep pipeline to carry away the product gas.

2. The membrane reactor with divergent-flow channel of claim 1, wherein the reaction pipeline further includes a catalyst layer filled in the reaction pipeline and provided for catalyzing a reaction, and a plurality of pores for flowing the reaction gas or the product gas through the pores.

3. The membrane reactor with divergent-flow channel of claim 1, wherein the sweep pipeline has a cross-sectional area decrement from the upstream end to the downstream end of the sweep pipeline.

4. A membrane reactor with divergent-flow channel, comprising:
a sweep pipeline;
a membrane, disposed on an external side of the sweep pipeline; and
a reaction pipeline, installed on an external side of the membrane, and having a cross-sectional area increment from the upstream end to the downstream end of the reaction pipeline, and a reaction gas being reacted in the reaction pipeline to generate a product gas, and the product gas passing from the reaction pipeline into the sweep pipeline through the membrane, and a purge gas flowing from the upstream end to the downstream end of the sweep pipeline to carry away the product gas.

5. The membrane reactor with divergent-flow channel of claim 4, wherein the sweep pipeline has a cross-sectional area decrement from the upstream end to the downstream end of the sweep pipeline.

6. The membrane reactor with divergent-flow channel of claim 4, wherein the reaction pipeline further includes a catalyst layer filled in the reaction pipeline and provided for catalyzing a reaction, and a plurality of pores for flowing the reaction gas or the product gas through the pores.
